(19) United States
(12) Patent Application Publication
(10) Pub. No.: US 2008/0162922 A1
(43) Pub. Date: Jul. 3, 2008

(54) Fragmenting security encapsulated ethernet frames

(76) Inventor: Troy A. Swartz, Chapel Hill, NC (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/646,201

(22) Filed: Dec. 27, 2006

(51) Int. Cl. H04L 9/00

(52) U.S. Cl. 713/150

(57) ABSTRACT

Providing security functions, such as data origin authentication, data integrity, and data confidentiality to data packets communicated over a communications pathway, in some instances, may result in data packets too large in size to be communicated over the pathway. A technique is provided which security encapsulates a data packet, and in event the size of the security encapsulated data packet exceeds a maximum data packet size capable of being transmitted over a communications pathway, fragments the security encapsulated data packet. As such, the provided technique enables data packets to be secured with security functions and to be communicated over the communications pathway without being impacted by or otherwise affected by the properties of the communications pathway.

### BACKGROUND OF THE INVENTION

This invention relates generally to communication networks and in particular to a technique for securing communication at the Data Link Layer (Layer 2) of the Open System Interconnection (OSI) Reference Model. The Data Link Layer may provide for reliable transfer of information across the physical layer.

Data transferred over many communication networks are typically sent unsecured, without the benefit of encryption and/or strong authentication of the sender. Sending unsecured data on a communication network may make the data vulnerable to being intercepted, inspected, modified and/or redirected. To make data less prone to these vulnerabilities, many networks employ various security standards and protocols to secure network traffic transferred in their networks. This secured network traffic is typically transferred using data packets that are encoded according to a security standard and/or protocol. As used herein, a secure data packet is a data packet that has been secured using a security standard and/or protocol. Likewise, as used herein, an unsecured data packet is a data packet that has not been secured using a security standard and/or protocol.

One well-known widely-used standard for securing Internet Protocol (IP) traffic is the IP security (IPsec) standard. The IPsec standard comprises a collection of protocols that may be used to transfer secure data packets in a communication network. IPsec operates at the Network Layer (Layer-3) of the OSI Reference Model. A description of IPsec may be found in Request for Comments (RFC) 2401 through RFC 2412 and RFC 4301 through RFC 4309 all of which are available from the Internet 2412 and RFC 4301 through RFC 4309 all of which are available from the Internet Engineering Task Force (IETF). Two cryptographic protocols that are commonly used to encapsulate IPsec packets are the Authentication Header (AH) protocol and the Encapsulating Security Payload (ESP) protocol.

The AH protocol is primarily used to provide connectionless integrity and authentication of IP datagram traffic. The authentication enables the origin of the traffic to be verified and ensure that the traffic has not been altered in transit. Authentication and integrity of an IP packet is achieved using a keyed one-way hash function, such as Message Digest algorithm 5 (MD5) or Secure Hash Algorithm-1 (SHA-1), in combination with a secret that is shared between a sender of the packet and a receiver of the packet.

Like the AH protocol, the ESP protocol provides a means to authenticate and verify the integrity of IP traffic carried in a secured packet. In addition, the ESP protocol provides a means to encrypt the IP traffic to prevent unauthorized interception of the IP traffic. Like the AH protocol, the ESP uses an ICV to authenticate and check the integrity of a packet. Encryption is used to secure the IP traffic. Encryption is accomplished by applying an encryption algorithm to the IP traffic to encrypt it. Encryption algothrims commonly used with IPsec include Data Encryption Standard (DES), triple-DES and Advanced Encryption Standard (AES).

The payload of an Ethernet packet may be encrypted; however, encrypting the payload itself does not support authentication or other security functions as per IPsec. For example, the Institute of Electrical and Electronics Engineers (IEEE) 802.1AE Media Access Control Security (MACsec) standard integrates security protection into wired Ethernet to secure local area networks (LANs) from attacks. However, IEEE 802.1AE provides only hop-by-hop security, and not complete end-to-end security.

### SUMMARY OF THE INVENTION

What is needed is a technique for providing security functions, such as data origin authentication, data integrity, and data confidentiality to data packets communicated over Layer-2 of the OSI Reference Model without requiring modification of higher layers. In some instances, however, applying such a technique creates data packets which are too large in size to be transmitted over a communications pathway. Accordingly, what is further needed is a technique for fragmenting data packets for which security functions have been provided for.

A technique for encapsulating data packets at Layer-2 to provide security functions is described in a U.S. Provisional Patent Application No. 60/756,765 entitled “SECURITY ENCAPSULATION OF ETHERNET FRAMES,” filed Sep. 25, 2006, assigned to CipherOptics, Inc., which is hereby incorporated by reference in its entirety.

Embodiments of the present invention provide a technique for fragmenting security encapsulated data packets. In one embodiment, the technique entails security encapsulating a data packet and fragmenting the security encapsulated data packet in an event the size of the security encapsulated data packet exceeds a maximum data packet size capable of being transmitted over a communications pathway.

In another embodiment, a security encapsulated data packet is “fragmented” by dividing the security encapsulated data packet into a first security encapsulated data fragment and at least one second security encapsulated data fragment. Each security encapsulated data fragment has a portion of an encrypted payload of the security encapsulated data packet, a data fragment header which is identical to a data packet header of the security encapsulated data packet, and an encapsulation header.

In yet another embodiment, each security encapsulated data fragment is identified with a fragment identifier. The fragment identifier associates each security encapsulated data fragment with a security encapsulated data packet from which the data fragments were divided from. Each security encapsulated data fragment is further identified as being or not being a beginning fragment by setting a fragment flag. In this way, each security encapsulated data fragment is identified as being associated with a security encapsulated data packet and as being a beginning fragment or not.

In an alternative embodiment, setting a second fragment flag identifies a security encapsulated data fragment as being or not being an ending fragment. As such, in addition to identifying a beginning security encapsulated data fragment, an ending security encapsulated data fragment may also be identified.

In still yet another embodiment, a security encapsulated data packet is “fragmented” by re-assembling the security encapsulated data packet from a first security encapsulated data fragment and at least one second security encapsulated data fragment. Each security encapsulated data fragment has a portion of an encrypted payload of the security encapsulated data packet, a data fragment header which is identical to the data packet header of the security encapsulated data packet, and an encapsulation header.

In an embodiment, a security encapsulated data packet is re-assembled by: i) identifying each security encapsulated data fragment associated with the security encapsulated data packet from a fragment identifier and a fragment flag, ii) time-stamping each security encapsulated data fragment with a time of receipt, and iii) discarding a security encapsulated data fragment in an event the time of receipt time-stamped exceeds a timeout period. As such, this embodiment handles instances when a security encapsulated data fragment is dropped or the security encapsulated data packet cannot otherwise be re-assembled from security encapsulated data fragments.

In another embodiment, an encrypted payload of a security encapsulated data packet (re-assembled from security encapsulated data fragments) is de-encrypted.

In still another embodiment, a security encapsulator is configured to security encapsulate a data packet to form a security encapsulated data packet. A fragmenter is coupled to the security encapsulator and is configured to fragment the security encapsulated data packet in an event the size of the security encapsulated data packet exceeds a maximum data packet size capable of being transmitted over a communications pathway.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a network diagram of an example data communications network implementing an embodiment of the present invention;

FIG. 2A is a block diagram of an Ethernet frame;

FIG. 2B is a block diagram of a VLAN-tagged frame;

FIG. 3 is a block diagram illustrating a security encapsulated Ethernet frame in accordance with an embodiment of the present invention;

FIG. 4 is a block diagram illustrating in greater detail an encapsulation header of a security encapsulated Ethernet frame in accordance with an embodiment of the present invention;

FIG. 5 is a flow chart for an example process for fragmenting a security encapsulated data packet in accordance with an embodiment of the present invention;

FIG. 6 is a flow chart for an example process for dividing a security encapsulated data packet into security encapsulated data fragments in accordance with an embodiment of the present invention;

FIG. 7 is a flow chart for an example process for re-assembling a security encapsulated data packet from security encapsulated data fragments in accordance with an embodiment of the present invention; and

FIG. 8 is a block diagram of an example system for fragmenting a security encapsulated data packet in accordance with an embodiment of the present invention.

### DETAILED DESCRIPTION OF THE INVENTION

A description of example embodiments of the invention follows.

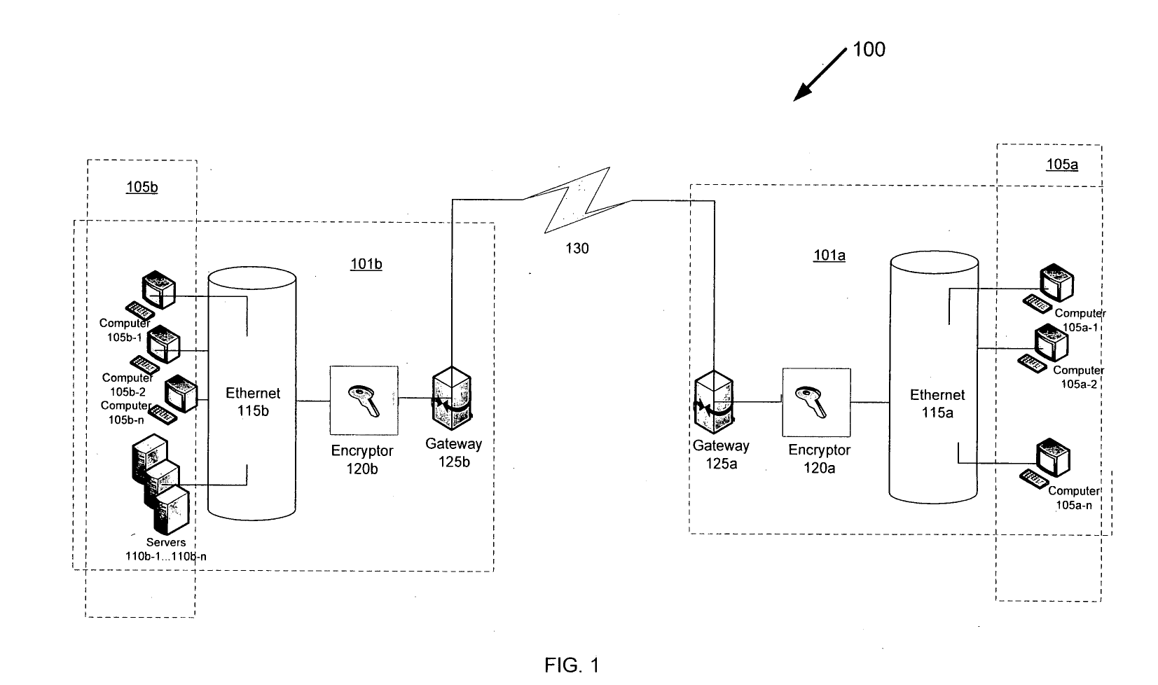

FIG. 1 is a high level diagram of an example data communication network 100 that consists of sub-network 101a and sub-network 101b interconnected by a communications pathway 130. An example sub-network 101a consists of a number of customer premises equipment (105a-1, 105a-2 . . . , 105a-n, generally 105a) that may receive and provide communications over the communications pathway 130. The customer premises equipment 105a may include Ethernet enabled devices such as personal computers, workstations, file servers, printers, Internet Protocol (IP) telephones, IP video devices and the like.

The customer premises equipment 105a may be interconnected by a local Ethernet network 115a. An encryptor appliance 120a is disposed in-line between the Ethernet network 115a and internetworking devices such as a gateway 125a. The gateway 125a provides connectivity over the communications pathway 130 so that customer premises equipment 105a may communicate with other customer premises equipment 105b connected by the communications pathway 130 such as computer terminals 105b-1, 105b-2, . . . , 105b-n (generally 105b) and servers 110b-1, . . . , 110b-n (generally 110b) in an example sub-network 101b.

Sub-network 101b may be similar to the sub-network 101a. Sub-network 101b may include a gateway 125b and an encryptor appliance 120b coupled to an Ethernet network 115b to provide network connectivity to customer premises equipment 105b and 110b.

In-line encryptor appliances 120a and 120b examine Ethernet packet traffic traveling between the Ethernet network 115a and the gateway 125a, and the Ethernet network 115b and the gateway 125b, respectively.

The in-line encryptor appliances 120a and 120b may modify the format of Ethernet packets. In particular, the in-line encryptor appliances 120a and 120b apply a security protocol to the Ethernet packets that provide data origin authentication, data integrity and data confidentiality through the use of security encapsulation of the Ethernet payload. Information concerning the security protocol to be applied, such as encryption keys, security associations, policies and the like, are provided to the in-line encryptor appliances 120a and 120b from elsewhere in the data communications network 100.

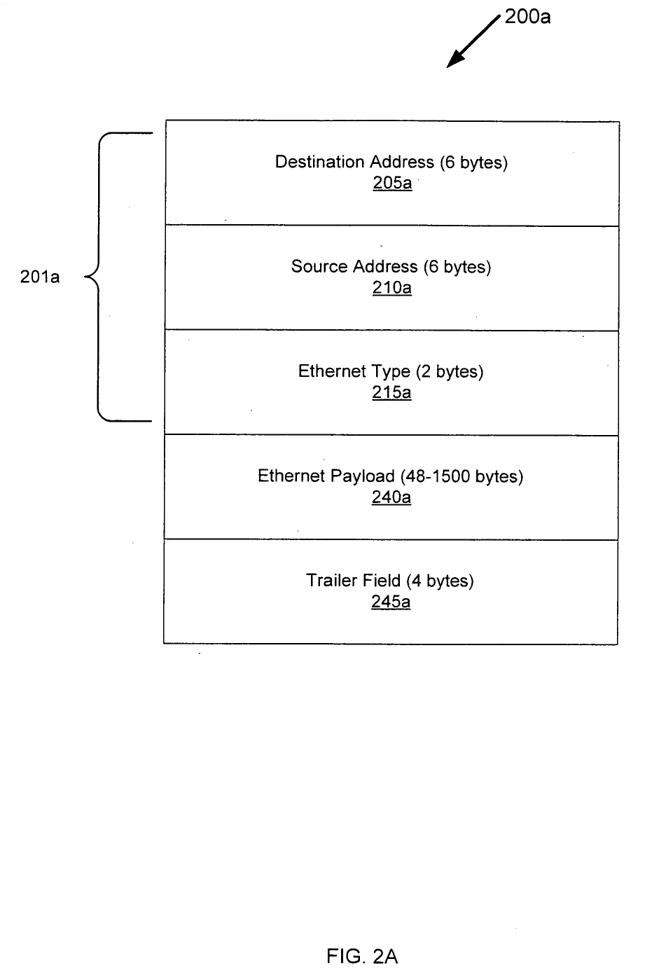

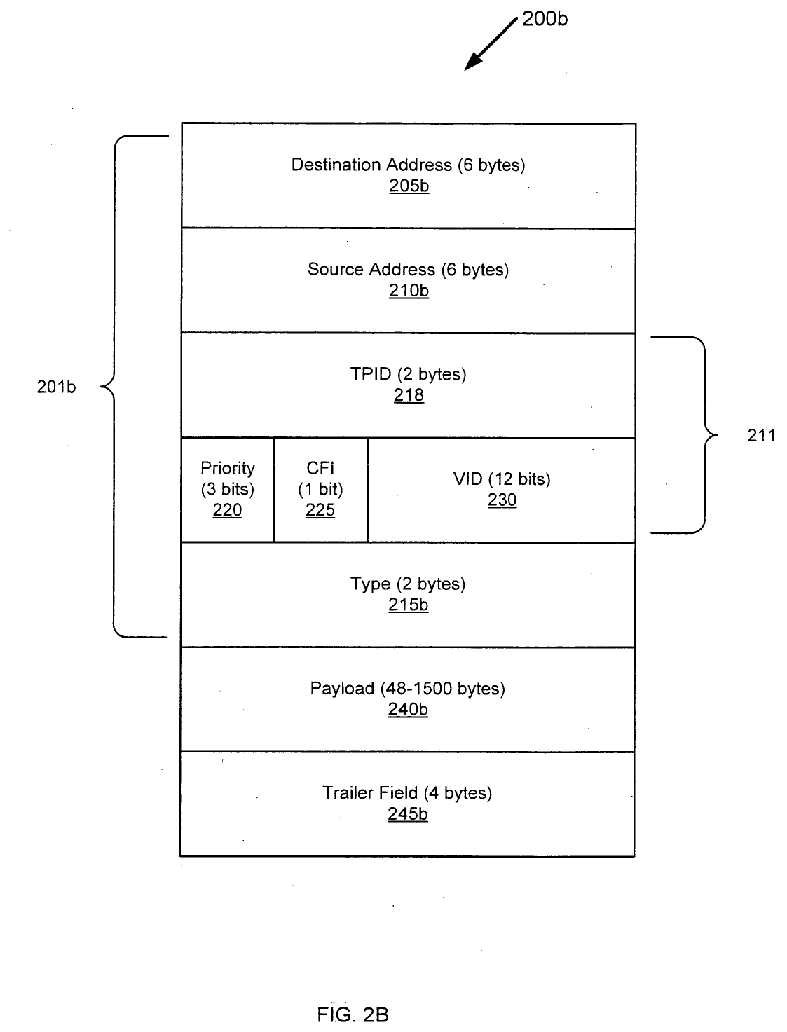

Ethernet packets from a network (e.g., sub-network 101a) to be modified by an encryptor (e.g., the encryptor 120a) may have an Ethernet frame format described in reference in FIG. 2.

FIG. 2A illustrates an Ethernet frame 200a, as is well known in the art. The Ethernet frame 200a consists of an Ethernet header 201a which includes a destination address 205a of 6 bytes, a source address 210a of 6 bytes, and an Ethernet type field 215a of 2 bytes. The Ethernet type field 215a indicates a type of information being carried by the Ethernet frame 200 and is used by multi-protocol devices to decide how an Ethernet frame should be handled. The Ethernet header 201a is followed by an Ethernet payload field 240a, which may be 48-1500 bytes long. Following the Ethernet payload field 240a is a trailer field 245a of 4 bytes. The trailer field 245a may be, for example, a cyclic redundancy check (CRC) or other checksum, calculated to detect errors after transmission.

FIG. 2B illustrates an Institute of Electrical and Electronics Engineers (IEEE) 802.1Q frame 200b (referred hereinafter as a virtual local area network (VLAN) frame). Similar to the Ethernet frame 200a of FIG. 2A, the VLAN frame 200b consists of a 802.1Q header 201b which includes a destination address 205b of 6 bytes, a source address 210b of 6 bytes, and a type field 215b of 2 bytes. The VLAN frame 200b further includes a VLAN tag 211 located between the source address 210b and the type field 215b. The VLAN tag 211 is made up of a tag protocol identifier (TPID) 218 to identify the VLAN frame 200b as an IEEE 802.1Q-tagged frame, a priority field 220 to assign a priority level, a canonical format indicator (CFI) 225 to indicate the presence of a routing information field (RIF), and Virtual Local Area Network (VLAN) Identifier (VID) 230. The VLAN tag 211 is 4 bytes long, and as such, the 802.1Q header 201b is 4 bytes longer than the Ethernet header 201b.

Following the 802.1Q header 201b is a payload field 240b, which may be 48-1500 bytes long. The payload field 240b is followed by a trailer field 245b of 4 bytes. The trailer field 245b may be, for example, a cyclic redundancy check (CRC) or other checksum, calculated to detect errors after transmission.

One skilled the art will readily recognize that the principles of the embodiments of the present invention also apply to other data structures used for network communications. For example, an IEEE 802.2 Logical Link Control (LLC)/Subnetwork Access Protocol (SNAP) frame is also within the contemplation of the present invention.

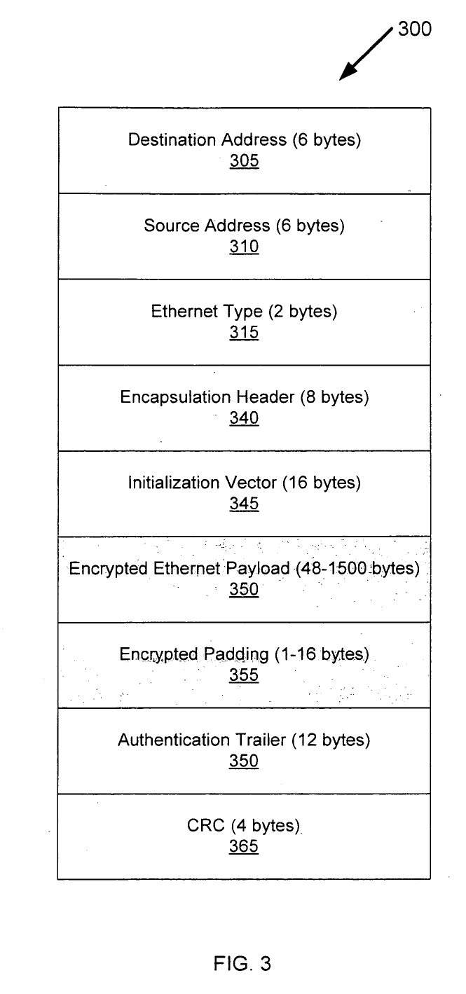

FIG. 3 is a block diagram illustrating a security encapsulated data packet 300 after being processed by an in-line encryptor (e.g., the in-line encryptor 120a of FIG. 1). The in-line encryptor receives an original Ethernet frame (e.g., the Ethernet frame 200a of FIG. 2A). The in-line encryptor encrypts an original Ethernet payload (e.g., the Ethernet payload 240A of FIG. 2A) to provide an encrypted Ethernet payload 350. As such, the original Ethernet payload of the original Ethernet frame is now the encrypted Ethernet payload 350 of the security encapsulated data packet 300.

The Ethernet header (e.g., the Ethernet header 201a of FIG. 2A) of the original Ethernet frame is copied or is otherwise re-used as the Ethernet header for the security encapsulated data packet 300. In this way, the security encapsulated data packet 300 has a destination address 305, a source address 310, and an Ethernet type 315 which are same as the destination address, the source address, and the Ethernet type of the original Ethernet frame.

The security encapsulated data packet 300 also includes an encapsulation header 340, initialization vector 345, encrypted padding 355 (if required, as described below), and an authentication trailer 360. The security encapsulated data packet 300 further includes a CRC field 365. It should be understood the CRC field of the original Ethernet frame differs for the CRC field 365 for the security encapsulated data packet 300.

In an event, the original frame is a VLAN frame, i.e., the frame is tagged with a VLAN tag, the VLAN tag (described in reference to FIG. 2B) of the VLAN frame becomes or is otherwise re-used as the VLAN tag for the security encapsulated packet data packet 300.

One skilled in the art will readily recognize that the principle described in reference to the above embodiment is also applicable to other features and is not intended to be limited to VLAN. For example, in an event an original frame includes Multi-Protocol Label Switching (MPLS) labels, such labels are copied or otherwise re-use for the security encapsulated data packet 300 in the same location and without modification.

The Ethernet payload 350 may be encrypted using an encryption algorithm such as the Advanced Encryption Standard (AES)-256 Cipher Block Chaining (CBC) encryption algorithm. With the AES-256 CBC encryption algorithm, an Ethernet payload, such as the Ethernet payload 240b for FIG. 2B, is padded with 1 to 16 bytes to adhere to the encryption algorithm's 128-bit block size, and then encrypted using the encryption algorithm to produce the encrypted Ethernet payload 350 and the encrypted padding 355.

It should be noted that other encryption algorithms may not require a “fixed” or otherwise predetermined block size, as is required by the AES-256 CBC encryption algorithm. In such cases padding is not required. Consequently, the security encapsulated data packet 300 may or may not include the encrypted padding 355 depending on whether an encryption algorithm used to encrypt the encrypted Ethernet payload 350 requires a fixed block size.

Continuing to refer to FIG. 3, the shaded area of FIG. 3 (i.e., the encrypted Ethernet payload 350 and the encrypted padding 355) illustrates the portion of the security encapsulated data packet 300 that is encrypted. With the required encrypted padding, the encrypted payload is consequently longer than the Ethernet payload of the original Ethernet frame.

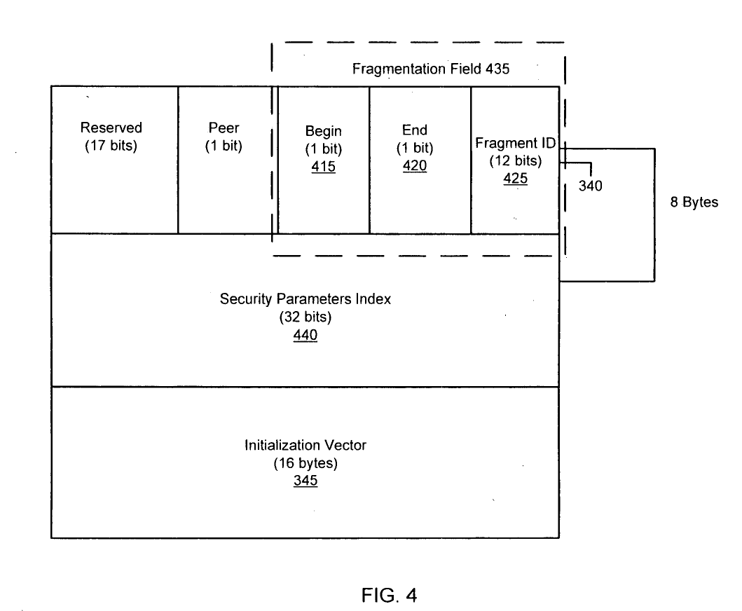

FIG. 4 illustrates in greater detail the encapsulation header 340 and the initialization vector 345 portions of the security encapsulated data packet 300 of FIG. 3. The encapsulation header 340 includes at least a 14-bit fragmentation field 435 and a 32-bit Security Parameters Index (SPI) 440 used to identify security parameters for encapsulating and encrypting data packets. In one embodiment, the encapsulation header 340 and the SPI 440, together with other fields, make up 8 bytes which are inserted before the encrypted Ethernet payload 340 of the security encapsulated data packet 300. The initialization vector 345 is 16 bytes and is used in the encryption de-encryption processes.

Certain communications pathways strictly limit the size of a data packet capable of being transmitted over the communications pathways (e.g., 1500 bytes). Applying a security encapsulation technique, such as the one described above, in some instances, however, result in a security encapsulated data packet whose size exceeds the size limitation for a communication pathway.

Returning to FIG. 4, the fragmentation field 435 is used by a fragmentation and reassembly technique according to an embodiment of the present invention to allow a security encapsulated data packet to be transmitted over a communications pathway despite having a size exceeding a maximum data packet size capable of being transmitted over the communications pathway. As such, the security encapsulated data packet can be transmitted without being impacted by or otherwise affected by the properties of the communications pathway.

In brief overview, in an event the size of a security encapsulated data packet exceeds a maximum size capable of being transmitted over a communications pathway the security encapsulated data packet is fragmented. The security encapsulated data packet is divided into a first security encapsulated data fragment and at least one second security encapsulated data fragment; each security encapsulated data fragment having a size within (i.e., less than or equal to) the maximum size capable of being transmitted over a communications pathway. Each security encapsulated data fragment has a fragmentation field 435, which includes, for example, a 12-bit fragment identifier field 425, a 1-bit beginning fragment flag 415, and 1-bit ending fragment flag 420. One skilled in the art will readily appreciated the “bit-sizes” of the aforementioned are provided merely as examples.

The fragment identifier field 425 and the beginning and end fragment flags, 415 and 420, respectively, are used to identify security encapsulated data fragments associated with the security encapsulated data packet (greater details are provided below). The security encapsulated data packet is re-assembled from the security encapsulated data fragments associated with the security encapsulated data packet.

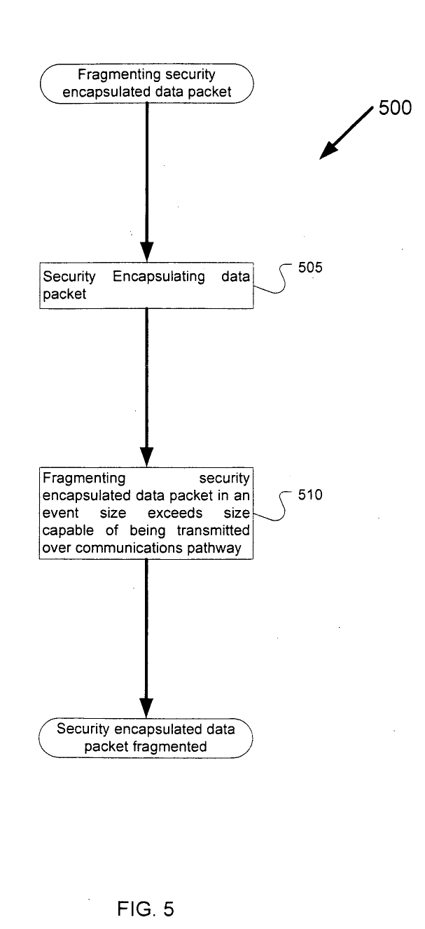

FIG. 5 illustrates an example process for fragmenting a security encapsulated data packet. A process 500 security encapsulates (505) a data packet. The process 500, fragments (510) the security encapsulated data packet in an event the size of the security encapsulated data packet exceeds a maximum data packet size capable of being transmitted over a communications pathway.

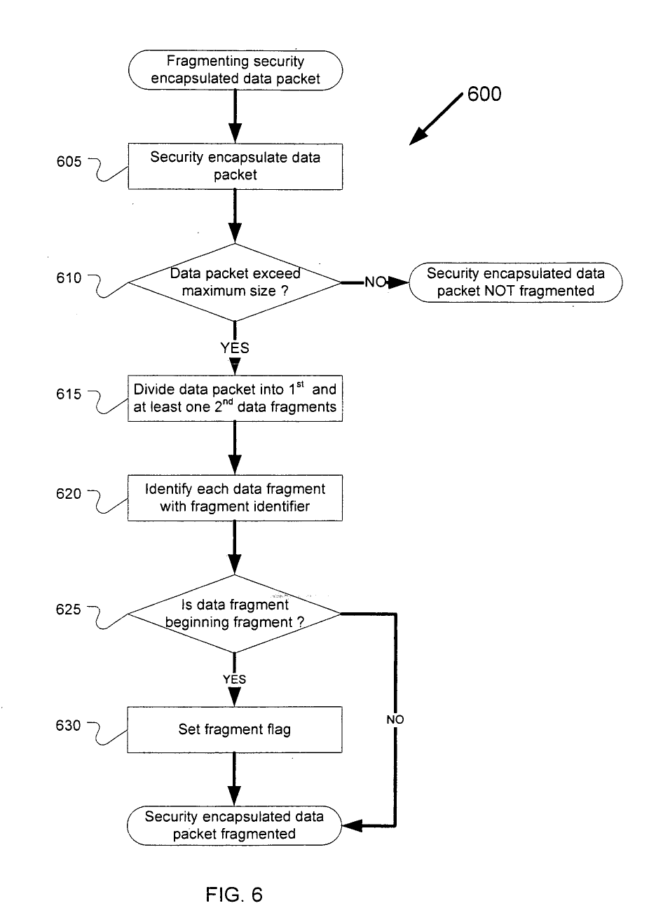

FIG. 6 illustrates an example process for fragmenting a security encapsulated data packet. A process 600 security encapsulates (605) a data packet, resulting in or otherwise creating a security encapsulated data packet. The process 600 decides (610) whether the size of the security encapsulated data packet exceeds a maximum size capable of being transmitted over a communications pathway. In an event the size of the security encapsulated data packet exceeds the maximum size capable of being transmitted over the communications pathway, the process 600 divides (615) the security encapsulated data packet into a first security encapsulated data fragment and at least one second security encapsulated data fragment.

The number of security encapsulated data fragments, and thus how many times the process 600 divides (615), may be dictated, for example, by the maximum data packet size capable of being transmitted or otherwise supported by the communications pathway. Consider the following example: the maximum data packet size supported by a communications pathway is 1500 bytes and a security encapsulated data packet is 1501 bytes. Ignoring headers, the 1501-byte security encapsulated data packet is divided into a first security encapsulated data fragment of 1500 bytes and a second security encapsulated data fragment of 1 byte. In another example, a security encapsulated data packet is divided equally or near equally. Again, ignoring headers, a 1501-byte security encapsulated data packet is divided into a first security encapsulated data fragment of 750 bytes and a second security encapsulated data fragment of 751 bytes.

The number of security encapsulated data fragments which a security encapsulated data packet is divided into is not significance. What is of significance, however, is that in an event the size of a security encapsulated data packet exceeds a maximum size capable of being transmitted over a communications pathway, the security encapsulated data packet is fragmented in such a manner that each resulting security encapsulated data fragment does not exceed the maximum size capable of being transmitted over the communications pathway. As such, communicating data packets over a communications pathway is not affected or otherwise impacted by the security encapsulating data packets.

Each security encapsulated data fragment has at least a portion of an encrypted payload of a security encapsulated data packet, a data fragment header identical to the data packet header of the security encapsulated data packet, and an encapsulation header. See e.g., FIG. 3. The encapsulation header of the security encapsulated data fragment may include, for example, the fragmentation field 435 of FIG. 4.

Continuing with FIG. 6, the process 600 identifies (620) each security encapsulated data fragment with a fragment identifier. In this way, security encapsulated data fragments are identified as being associated with a particular security encapsulated data packet by fragment identifiers.

The process 600 decides (625) whether the data fragment is a beginning fragment. In an event the data fragment is a beginning fragment, the process 600 sets (630) a fragment flag. In this way, data fragments are further identified by as being or not being a beginning fragment for a particular security encapsulated data packet. The security encapsulated data packet is consequently fragmented by the process 600 into security encapsulated data fragments.

In an alternative embodiment, setting a second fragment flag identifies a security encapsulated data fragment as being or not being an ending fragment. As such, in addition to identifying a beginning security encapsulated data fragment, an ending security encapsulated data fragment may also be identified.

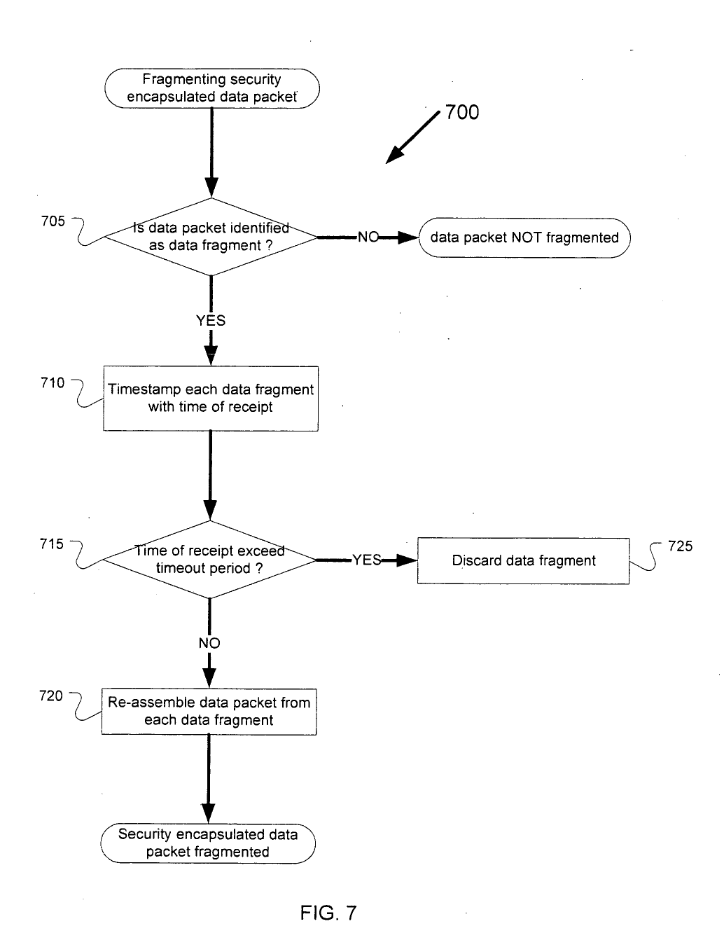

FIG. 7 illustrates an example process for fragmenting a security encapsulated data packet. The process 700 identifies (705) whether a data packet is a security encapsulated data fragment. Mentioned previously in reference to FIG. 6, a fragment identifier identifies a security encapsulated data fragment as being associated with a particular security encapsulated data packet. Further, a fragment flag identifies a security encapsulated data fragment as being or not being a beginning fragment for a security encapsulated data packet.

In an event, the process 700 identifies (705), the data packet as a security encapsulated data fragment, the process 700 timestamps (710) the security encapsulated data fragment with a time of receipt.

A security encapsulated data packet is re-assembled from all security encapsulated data fragments identified as being associated with that particular security encapsulated data packet. However, in some instances, while identified as apparently being associated with a particular security encapsulated data packet, the identified security encapsulated data fragment may in fact be associated with more than one security encapsulated data packet.

Consider the following example: three data packets are security encapsulated to produce three security encapsulated data packets. The three security encapsulated data packets are identified with an identifier from a set of identifiers consisting of a numeral 1 and a numeral 2.

The security encapsulated data packets are identified with an identifier in a “round-robin” fashion. That is, all identifiers in the set of identifiers are equally chosen in some order, e.g., from the bottom of the set to the top of the set. In an event there are more security encapsulated data packets to identify than there are identifiers the order starts again e.g., starting from the bottom of the set. In others words, additional security encapsulated data packet are identified by “wrapping around” or otherwise re-using the identifiers.

For example, the first security encapsulated data packet is identified with a numeral 1, the second security encapsulated data packet is identified with a numeral 2, and third security encapsulated data packet is identified with numeral 1 again. For clarity and for the sake of explaining an embodiment of the present invention, the third security encapsulated data packet is identified with a 1′ (one prime).

The three security encapsulated data packets (identified as 1, 2, and 1′) are each fragmented or otherwise divided into two security encapsulated data fragments, i.e., 1A, 1B, 2A, 2B, 1′A, and 1′B.

All security encapsulated data fragments are sent. Unfortunately, security encapsulated data fragment 1B is dropped or otherwise lost during transmission. In this example, the remaining security encapsulated data fragments are received in the order they were sent.

Security encapsulated data fragments 1A, 1′A and 1′B are all identified as being associated with the security encapsulated data packet identified by the numeral 1 and 1′. However, only security encapsulated data fragments 1′A and 1′B are associated with the security encapsulated data packet identified as 1′. Since, security encapsulated data fragment 1B was dropped, security encapsulated data fragment 1A is no longer validly associated with the security encapsulated data packet identified as 1.

In another example, three data packets are security encapsulated resulting in three security encapsulated data packets. The sizes of the security encapsulated data packets exceed a maximum size capable of being transmitted over a communications pathway. Consequently, each security encapsulated data packet is fragmented or otherwise divided into two or more security encapsulated data fragments. In fragmenting or otherwise generating security encapsulated data fragments of the security encapsulated data packets, each security encapsulated data packet is identified with an identifier. The identifier is limited to either a numeral 1 or a numeral 2. Due to the limited number of identifiers, an identifier is re-used after all other identifiers have been used.

Returning to FIG. 7, to handle such instances, the process 700 decides (715) whether the time of receipt time-stamped for each security encapsulated data fragment exceeds a timeout period. In an event, the time of receipt time-stamped does not exceed the timeout period, the process 700 re-assembles (720) a security encapsulated data packet from all of the security encapsulated data fragments associated with that security encapsulated data packet. However, in an event, the time of receipt time-stamped for a security encapsulated data fragment exceeds the timeout period, the process 700 discards (725) the security encapsulated data fragment.

In alternative embodiment, a timestamp is used with a fragment identifier to correctly associate a security encapsulated data fragment with a security encapsulated data packet.

The process 700, having re-assembled (720) the security encapsulated data packet, may optionally “de-encapsulate” the security encapsulated data packet to produce a data packet (e.g., the data packet security encapsulated by the process 600 in FIG. 6). In one embodiment (not shown) to de-encapsulate the security encapsulated data packet, the process 700: i) authenticates the security encapsulated data packet, ii) de-encrypts an encrypted payload and encrypted padding (if present, as described in reference to FIG. 3) of the security encapsulated data packet (described in reference to FIG. 3), iii) removes an encapsulation header, an initialization vector, the padding (if present, as described in reference to FIG. 3), and an authentication header from the security encapsulated data packet (described in reference to FIG. 3) or iv) any combination thereof, to produce the data packet.

It should be readily appreciated by those of ordinary skill in the art that the aforementioned steps of FIGS. 6 and 7 are provided as mere examples and the present invention is in no way limited to the number of steps or the ordering of steps described above.

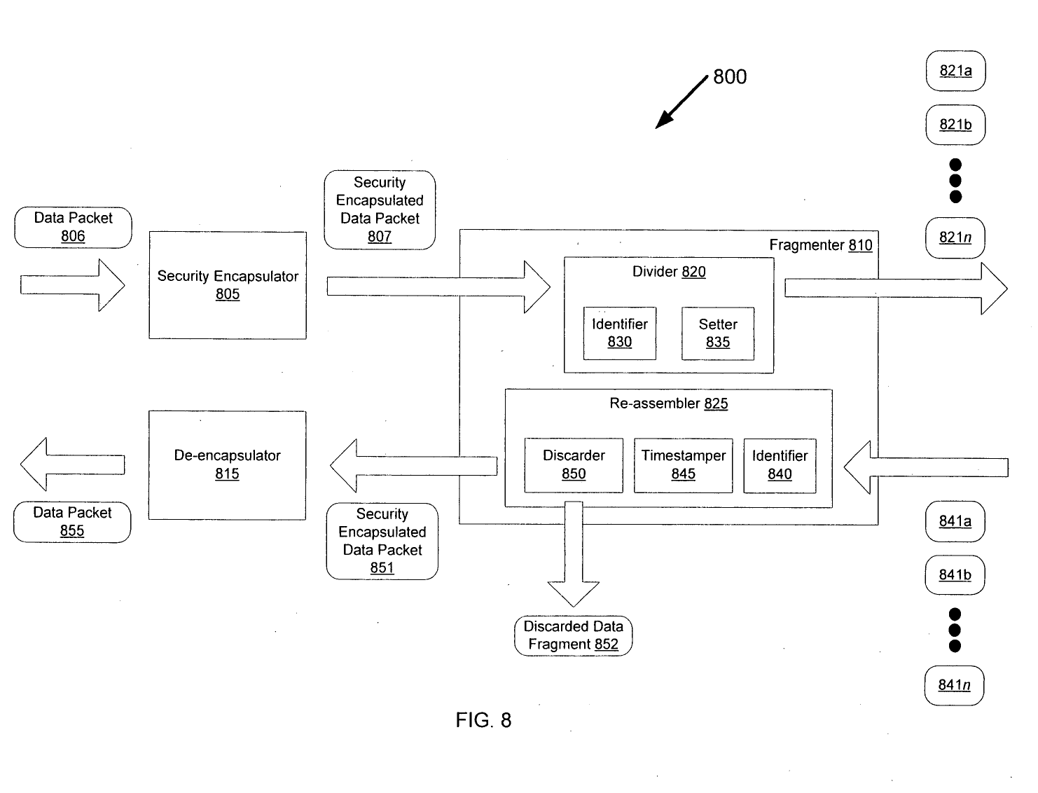

FIG. 8 illustrates an example system for fragmenting security encapsulated data packets. In brief overview, a system 800 includes a security encapsulator 805, a fragmenter 810, and an optional de-encapsulator 815.

The security encapsulator 805 security encapsulates a data packet 806 to yield or otherwise generate a security encapsulated data packet 807. In an event, the size of the security encapsulated data packet 807 exceeds a maximum size capable of being transmitted over a communications pathway, a divider 820 divides the security encapsulated data packet 807 into a first security encapsulated data fragment 821a and at least one second security encapsulated data fragment 821b . . . 821n (generally, 821).

In contrast, in an event the size of the security encapsulated data packet 807 does not exceed the maximum size capable of being transmitted over the communications pathway, the security encapsulated data packet 807 is not divided by the divider 820, but is transmitted as is without further processing.

In an alternative embodiment, in an event a security encapsulated data packet does not exceed a maximum size capable of being transmitted over a communications pathway the security encapsulated data packet “by-passes” or is otherwise not processed by a fragmenter and is transmitted without further processing.

The security encapsulated data fragments 821 are identified with fragment identifiers by an identifier 830. A fragment identifier associates each security encapsulated data fragment 821 with a particular security encapsulated data packet. Each security encapsulated data fragment 821 is further identified as being or not being a beginning fragment by a fragment flag set by a setter 835. As such, each security encapsulated data fragment 821 is identified as being associated with a particular security encapsulated data packet and as being a beginning fragment or not.

In an alternative embodiment, the setter 835 sets a second fragment flag identifying a security encapsulated data fragment as being or not being an ending fragment. As such, in addition to identifying a beginning security encapsulated data fragment, the setter 835 also identifies an ending security encapsulated data fragment.

The re-assembler 825 re-assembles a security encapsulated data packet from security encapsulated data fragments associated the security encapsulated data packet. An identifier 840, using a fragment identifier and a fragment flag, identifies each security encapsulated data fragment 841a, 841b . . . 841n (generally, 841) as being associated with particular security encapsulated data packets and whether the fragment 841 is a beginning fragment or not.

A timestamper 845 timestamps each security encapsulated data fragment 841 with a time of receipt. In an event the time of receipt time-stamped does not exceed a timeout period, the security encapsulated data fragments 841 are re-assembled into a security encapsulated data packet 851. In an event the time of receipt time-stamped exceeds a timeout period, however, a discarder 850 discards the fragment as a discarded data fragment 852.

In alternative embodiment, an identifier (e.g., the identifier 840) and a timestamper (e.g., the timestamper 845) work together to correctly associate a security encapsulated data fragment with a security encapsulated data packet.

The optional de-encapsulator 815 de-encapsulates a re-assembled security encapsulated data packet 851 to yield a data packet 855. In one embodiment, the de-encapsulator 815 de-encapsulates the security encapsulated data packet by: i) authenticating the security encapsulated data packet 851, ii) de-encrypting an encrypted payload and encrypted padding (if present, as described in reference to FIG. 3) of the security encapsulated data packet 851 (described in reference to FIG. 3) iii) removing an encapsulation header, an initialization vector, the padding (if present, as described in reference to FIG. 3) and an authentication header from the security encapsulated data packet 851 (described in reference to FIG. 3) or iv) any combination thereof, to yield a data packet 855.

While this invention has been particularly shown and described with references to preferred embodiments thereof, it will be understood by those skilled in the art that various changes in form and details may be made therein without departing from the scope of the invention encompassed by the appended claims.

Furthermore, it should be understood that elements of the block diagrams, network diagrams, and flow diagrams described above may be implemented in software, hardware, or firmware. In addition, the elements of the block diagrams and flow diagrams described above may be combined or divided in any manner in software, hardware, or firmware. If implemented in software, the software may be written in any language that can support the embodiments disclosed herein. The software may be stored on any form of computer-readable medium, such as RAM, ROM, CD-ROM, and so forth. In operation, a general purpose or application specific processor loads and executes the software in a manner well understood in the art.

Although described primarily in reference to fragmenting security encapsulated Ethernet frames, it should be understood that other data structures used for network communications which have been security encapsulated may be fragmented as well in accordance with various embodiments of the present invention.

What is claimed is:

1. A method for fragmenting a security encapsulated data packet comprising:
security encapsulating a data packet to form a security encapsulated data packet; and
fragmenting the security encapsulated data packet in an event the size of the security encapsulated data packet exceeds a maximum data packet size capable of being transmitted over a communications pathway.

2. The method of claim 1 wherein fragmenting includes dividing the security encapsulated data packet into a first security encapsulated data fragment and at least one second security encapsulated data fragment, each security encapsulated data fragment having a portion of an encrypted payload of the security encapsulated data packet, a data fragment header identical to a data packet header of the security encapsulated data packet, and an encapsulation header.

3. The method of claim 1 wherein fragmenting includes re-assembling the security encapsulated data packet from a first security encapsulated data fragment and at least one second security encapsulated data fragment, each security encapsulated data fragment having a portion of an encrypted payload of the security encapsulated data packet, a data fragment header identical to the data packet header of the security encapsulated data packet, and an encapsulation header.

4. The method of claim 2 wherein dividing includes:
identifying each security encapsulated data fragment associated with the security encapsulated data packet being divided with a fragment identifier; and
setting a fragment flag in an event a security encapsulated data fragment is a beginning fragment.

5. The method of claim 4 further comprising setting a second fragment flag in an event a security encapsulated data fragment is an ending fragment.

6. The method of claim 4 wherein identifying includes reusing fragment identifiers in an event the number of security encapsulated data fragments exceeds the number of fragment identifiers available.

7. The method of claim 4 wherein identifying includes reusing fragment identifiers in a round-robin manner in an event the number of security encapsulated data fragments exceeds the number of fragment identifiers available.

8. The method of claim 3 wherein re-assembling includes associating each security encapsulated data fragment with a security encapsulated data packet being re-assembled using a fragment identifier of each security encapsulated data fragment and a time of receipt of each security encapsulated data fragment.

9. The method of claim 3 wherein re-assembling includes:
identifying each security encapsulated data fragment associated with the security encapsulated data packet being re-assembled from a fragment identifier and a fragment flag;
time-stamping each security encapsulated data fragment with a time of receipt; and
discarding a security encapsulated data fragment in an event the time of receipt time-stamped exceeds a timeout period.

10. The method of claim 3 further comprising de-encapsulating the security encapsulated data packet re-assembled from the security encapsulated data fragments.

11. The method of claim 10 wherein de-encapsulating the security encapsulated data packet includes:
authenticating the security encapsulated data packet re-assembled from the security encapsulated data fragments;
de-encrypting the encrypted payload of the security encapsulated data packet re-assembled from the security encapsulated data fragments; and
removing an encapsulation header, an initialization vector, and an authentication header from the security encapsulated data packet re-assembled from the security encapsulated data fragments.

12. A system for fragmenting a security encapsulated data packet comprising:
a security encapsulator configured to security encapsulate a data packet to form a security encapsulated data packet;
a fragmenter coupled to the security encapsulator and configured to fragment the security encapsulated data packet in an event the size of the security encapsulated data packet exceeds a maximum data packet size capable of being transmitted over a communications pathway.

13. The system of claim 12 wherein the fragmenter includes a divider adapted to divide the security encapsulated data packet into a first security encapsulated data fragment and at least one second security encapsulated data fragment, each security encapsulated data fragment having a portion of an encrypted payload of the security encapsulated data packet, a data fragment header identical to a data packet header of the security encapsulated data packet, and a encapsulation header.

14. The system of claim 12 wherein the fragmenter includes a re-assembler adapted to re-assemble the security encapsulated data packet from a first security encapsulated data fragment and at least one second security encapsulated data fragment, each security encapsulated data fragment having a portion of an encrypted payload of the security encapsulated data packet, a data fragment header identical to the data packet header of the security encapsulated data packet, and an encapsulation header.

15. The system of claim 13 wherein the divider includes:
an identifier adapted to identify each security encapsulated data fragment associated with the security encapsulated data packet being divided with a fragment identifier; and
a setter adapted to set a fragment flag in an event a security encapsulated data fragment is a beginning fragment.

16. The system of claim 15 wherein the setter is adapted to set a second fragment flag in an event a security encapsulated data fragment is an ending fragment.

17. The system of claim 14 wherein the re-assembler includes an identifier adapted to associate each security encapsulated data fragment with a security encapsulated data packet being re-assembled using a fragment identifier of each security encapsulated data fragment and a time of receipt of each security encapsulated data fragment.

18. The system of claim 14 wherein the re-assembler includes:
an identifier adapted to identify each security encapsulated data fragment associated with the security encapsulated data packet being re-assembled from a fragment identifier and a fragment flag;
a timestamper adapted to timestamp each security encapsulated data fragment with a time of receipt; and
a discarder adapted to discard a security encapsulated data fragment in an event the time of receipt time-stamped exceeds a timeout period.

19. The system of claim 13 further comprising a de-encapsulator adapted to de-encapsulate the security encapsulated data packet re-assembled from the security encapsulated data fragments.

20. An apparatus for fragmenting a security encapsulated data packet comprising:
means for security encapsulating a data packet to form a security encapsulated data packet; and
means for fragmenting the security encapsulated data packet in an event the size of the security encapsulated data packet exceeds a maximum data packet size capable of being transmitted over a communications pathway.

21. A computer program product comprising:
a computer usable medium embodying computer usable code for fragmenting a security encapsulated data packet, the computer program product including; computer usable program code for security encapsulating a data packet to form a security encapsulated data packet; and computer usable program code for fragmenting the security encapsulated data packet in an event the size of the security encapsulated data packet exceeds a maximum data packet size capable of being transmitted over a communications pathway.
